(19) United States
(12) Patent Application Publication
(10) Pub. No.: US 2025/0213019 A1
(43) Pub. Date: Jul. 3, 2025

(54) REINFORCED SHAVER CLEANING STATION CARTRIDGES AND METHODS FOR MANUFACTURING THE SAME

(71) Applicant: Braun GmbH, Kronberg (DE)

(72) Inventor: Marius Beat Hanner, Oberursel (DE)

(21) Appl. No.: 18/987,459

(22) Filed: Dec. 19, 2024

(30) Foreign Application Priority Data
Dec. 29, 2023 (EP) 23220665.6

(51) Int. Cl. A45D 27/46; B08B 3/14

(52) U.S. Cl. CPC A45D 27/46; B08B 3/14

(57) ABSTRACT

Provided is a shaver cleaning station cartridge for inserting into a slot defined in a shaver cleaning station. The cartridge is suitable for containing cleaning liquid for cleaning a shaver docked in the shaver cleaning station. Further provided is a method for manufacturing such a cartridge.

### FIELD OF THE INVENTION

The present disclosure relates to a shaver cleaning station cartridge, and a method for manufacturing such a cartridge.

The cartridge is used by inserting the cartridge into a shaver cleaning station. Cleaning liquid in the cartridge is applied to a shaver docked in the shaver cleaning station.

The present disclosure accordingly also provides a shaver cleaning station assembly comprising the shaver cleaning station, one or more of the cartridges, and optionally the shaver.

### BACKGROUND OF THE INVENTION

Maintenance of a shaver tends to involve cleaning the shaver, as well as lubricating moving parts of the shaver. Such maintenance can assist to prolong the operating lifetime of the shaver. Performing such maintenance can, however, be onerous for the user.

At least some of the burden on the user can be alleviated by the shaver being dockable in a shaver cleaning station capable of cleaning the shaver, for example specifically a shaving head of the shaver, when the shaver is docked in the shaver cleaning station.

A shaver cleaning station cartridge can provide cleaning liquid for applying to part(s) of the shaver, such as the shaving head, when the shaver is docked in the shaver cleaning station. The cartridge may be a consumable product that from time to time requires replacement.

US-B1-6874514 discloses a cleaning station and a cleaning cartridge for cleaning a shaver within the station and by means of the fluid pumped from the cartridge into the station. The cartridge comprises side ear projections of the overall outer shape which are used to create an abutment inside the cleaning station for the cartridge. A plurality of uniformly shaped compartment walls protrudes from an internal surface of a base portion into the interior space of the cartridge, the compartment walls defining compartments in which debris is collectable from the cleaning liquid received in the interior space from the shaver cleaning station.

### SUMMARY OF THE INVENTION

According to a first aspect of the present disclosure, there is provided a shaver cleaning station cartridge for inserting into a slot defined in a shaver cleaning station and for containing cleaning liquid suitable for cleaning a shaver docked in the shaver cleaning station, the cartridge comprising: a base portion; a cover portion; a first side wall portion and a second side wall portion that each upstand between the base portion and the cover portion to define, together with the base portion and the cover portion, a hollow section; a first end wall portion closing a first end of the hollow section; a second end wall portion closing a second end of the hollow section, the second end being opposite the first end, an interior space for receiving the cleaning liquid being defined within the hollow section between the first end wall portion and the second end wall portion; and an interface for establishing a fluid route for the cleaning liquid between the interior space and the shaver cleaning station when the cartridge is secured in the slot, wherein a plurality of compartment walls protrude from an internal surface of the base portion into the interior space, the compartment walls defining compartments in which debris is collectable from the cleaning liquid received in the interior space from the shaver cleaning station, wherein the compartment walls comprise first compartment walls and second compartment walls, the second compartment walls protruding further into the interior space from the internal surface than the first compartment walls, wherein the second compartment walls define at least opposite portions of a regular polygonal or circular shape of one or more of the compartments, when the internal surface is viewed in plan.

It is noted that the term “shaver” as used herein may refer to an electric device for cutting hairs that has at least one driven cutting blade whose movement relative to a further blade, for example a stationary blade, causes hair to be cut between the cutting blade(s) and the further blade.

The compartments may provide receptacles in which sedimentation of the debris, for example bristles etc., contaminating the cleaning liquid used to clean the shaver can take place. In addition to at least partly delimiting such compartments, the taller second compartment walls can add stiffness/rigidity to the base portion further to that intrinsically provided by the regular polygonal or circular shape of the compartment(s).

The enhanced stiffness/rigidity provided by the taller second compartment walls can assist manufacturing of the base portion, for example as well as assisting welding of a second thermoplastic component that comprises the base portion to a first thermoplastic component comprising the cover portion. In particular, the greater stiffness/rigidity of the base portion can reduce the risk of warping of the base portion that can otherwise hamper welding, for example mirror welding, of the first thermoplastic component to the second thermoplastic component.

It is noted that the welding process can require wall portions of the second thermoplastic component to be taller than the compartment walls, and in particular taller than the second compartment walls. In this way, the risk of melting of the compartment walls, including the second compartment walls, can be minimized, or removed during welding of the first and second thermoplastic components to each other.

Thus, not all walls included in the second thermoplastic component can simply be made taller, and this may account for the walls, and in particular the compartment walls, adjacent to the wall portions/connection area between the first and second thermoplastic components being shorter than the wall portions.

It follows that the compartment walls comprising the first compartment walls and the second, taller, compartment walls can work synergistically with the cartridge comprising the first and second thermoplastic components welded to each other to provide a robust cartridge whose manufacture via welding, for example mirror welding, is facilitated.

The enhanced stiffness/rigidity of the base portion can also assist to confer structural robustness to the cartridge, in particular in terms of assisting the base portion to withstand the vapor pressure of the cleaning liquid contained in the cartridge's interior space, for example during storage and transportation of the cartridge.

It is noted that the shorter first compartment walls may assist to minimize fluid flow inefficiency, whilst also assisting to reduce the amount of material, for example thermoplastic, included in the base portion.

In some embodiments, the second compartment walls define the entirety of the regular polygonal or circular shape of the compartment(s).

Alternatively, the second compartment walls may define the opposite portions of the regular polygonal or circular shape of each of one or more of the compartments, but with the remainder of the regular polygonal or circular shape being defined by the first compartment walls.

Examples of regular polygonal shapes for the compartments whose opposite portions are defined by the taller second compartment walls include square, hexagonal and octagonal. Particular mention is made of hexagonal compartments, in other words compartments that are each delimited by six hexagonally arranged compartment walls. In such an example, the taller second compartment walls may define one, two or all three opposite pairs of the hexagonally arranged compartment walls.

In some embodiments, the second compartment walls protrude into the interior space from the internal surface by at least 10%, preferably by at least 20%, more than the first compartment walls' protrusion into the interior space from the internal surface.

Alternatively, or additionally, the second compartment walls may protrude from the internal surface to a height of 3.5 mm to 4 mm, for example about 3.7 mm, with the first compartment walls protruding from the internal surface to a height of 2.7 mm to 3.2 mm, for example about 2.9 mm.

In some embodiments, the second compartment walls comprise a first interconnected arrangement of second compartment walls, with the first interconnected arrangement being elongate and longitudinally extending between the first end wall portion and the second end wall portion, adjacent to the first side wall portion. By increasing the height of the compartment walls in this way, adjacent to the first side wall portion, the enhanced stiffness provided by the second compartment walls may be provided in a region where there is more risk of bulging due to expansion of vapor from the cleaning liquid in the interior space.

Alternatively, or additionally, the second compartment walls may comprise a second interconnected arrangement of second compartment walls, with the second interconnected arrangement being elongate and longitudinally extending between the first end wall portion and the second end wall portion, adjacent to the second side wall portion.

This may also assist to enhance stiffness provided by the second compartment walls in a (further) region where there is more risk of bulging of the base portion due to expansion of vapor from the cleaning liquid in the interior space.

In some embodiments, the second compartment walls include the first interconnected arrangement and the second interconnected arrangement, for example with the first and second interconnected arrangements being distinct from each other, in other words without sharing second compartment wall(s) common to both of the first and second interconnected arrangements.

In such embodiments, the symmetry provided by inclusion of both of the first and second interconnected arrangements may assist manufacture of the base portion, for example by minimizing the risk of warping during molding of the second thermoplastic component that includes the base portion.

In some embodiments, the second compartment walls comprise a third interconnected arrangement of second compartment walls, with the third interconnected arrangement being arranged in a central region between the first side wall portion and the second side wall portion.

In such embodiments, the central region may, for example, be closer to the second end wall portion than the first end wall portion.

Such a third interconnected arrangement of second compartment walls can further assist to reduce the risk of bulging due to containment of the cleaning liquid in the interior space.

In some embodiments, a plurality of elongate support ribs protrudes from the internal surface of the base portion into the interior space, with the plurality of elongate support ribs comprising at least one longitudinal support rib extending between the first end wall portion and the second end wall portion and/or at least one lateral support rib extending between the first side wall portion and the second side wall portion. The combination of the second compartment walls and the elongate support rib(s) may lend particularly enhanced structural robustness to the base portion.

In some embodiments, the at least one longitudinal support rib comprises a first longitudinal support rib extending adjacent to the first side wall portion, and a second longitudinal support rib extending adjacent to the second side wall portion, with the first longitudinal support rib being spaced apart from the second longitudinal support rib.

Alternatively, or additionally, the at least one lateral support rib may comprise a first lateral support rib, and a second lateral support rib spaced apart from the first lateral support rib.

In some embodiments, the first end wall portion is distinguished from the second end wall portion at least in that the first end wall portion comprises a mounting feature for engaging with a locating part of the shaver cleaning station during securing of the cartridge in the slot. By the mounting feature being provided by the first end wall portion and not the second end wall portion, the risk of insertion of the cartridge into the slot in the wrong direction may be lessened.

In some embodiments, the mounting feature comprises an indentation defined in the first end wall portion, in which indentation at least a portion of the locating part is receivable.

The indentation defined in the first end wall portion may provide a straightforwardly manufacturable way of ensuring that the cartridge is correctly inserted in the slot.

The interior space may wrap (partially) around the indentation.

In this way, the interior space's volume may be maximized in spite of inclusion of the indentation in the mounting feature.

It is noted that the term “partially” (in parentheses) qualifying the wrapping of the interior space around the indentation reflects that the first end wall portion, that closes the first end of the cartridge's hollow section and in which the indentation is defined, inherently prevents the interior space from wrapping entirely around the indentation.

In some embodiments, the first side wall portion axially extends from the first end wall portion, with the axial extension of the first side wall portion reaching a juncture at which the first side wall portion meets the second end wall portion, at which juncture the second end wall portion extends towards the second side wall portion.

By the first side wall portion axially extending from the first end wall portion to the juncture with the second end wall portion, a relatively compact cartridge may be provided, which is more efficient to pack, store and ship.

The axial extension of the first side wall portion may refer to a first side wall portion whose linearity allows the first side wall portion to contact a planar surface over a length of the first side wall portion between where the first side wall portion meets the first end wall portion and where the first side wall portion meets the second end wall portion.

It is noted that the planar surface may, for example, be a side wall portion of another cartridge or a side wall of a carton for containing the cartridge.

The packability of the cartridge may be enhanced relative to, for example, a cartridge whose side wall portion comprises an outwardly protruding region arranged along the side wall portion between where the side wall portion meets the cartridge's end wall portions. Such an outwardly protruding region means that the side wall portion of such a cartridge is unable to contact a planar surface over its length.

Whilst the axially extending first side wall portion may potentially increase the risk of the user inserting the cartridge incorrectly into the shaver cleaning station's slot, this risk may be mitigated by the mounting feature being provided by the first end wall portion and not the second end wall portion.

Thus, even though the cartridge may be insertable into the slot leading with the first end wall portion or the second end wall portion, the mounting feature being provided specifically by the first end wall portion may assist the user to secure the cartridge correctly in the slot.

In some embodiments, the first side wall portion extends in a flat plane between where the first side wall portion meets the first end wall portion (in other words the point at which the first end wall portion extends from the first side wall portion towards the second side wall portion) and the juncture between the first side wall portion and the second end wall portion.

In some embodiments, the second side wall portion axially extends from the first end wall portion, with the axial extension of the second side wall portion reaching a further juncture at which the second side wall portion meets the second end wall portion, at which further juncture the second end wall portion extends towards the first side wall portion. This may enhance the compactness and packability of the cartridge, for reasons analogous to those provided above in respect of the axially extending first side wall portion.

The axial extension of the second side wall portion may refer to a second side wall portion whose linearity allows the second side wall portion to contact a planar surface over a length of the second side wall portion between where the second side wall portion meets the first end wall portion and where the second side wall portion meets the second end wall portion.

In some embodiments, the second side wall portion extends in a flat plane between where the second side wall portion meets the first end wall portion (in other words the point at which the first end wall portion extends from the second side wall portion towards the first side wall portion) and the further juncture between the second side wall portion and the second end wall portion.

In some embodiments, the first and second side wall portions axially extend parallel to each other. Such parallel first and second side wall portions may additionally enhance the compactness and packability of the cartridge.

In such embodiments, the hollow section of the cartridge, defined by the first and second side wall portions upstanding between the base portion and the cover portion, may comprise a box section.

Such a box section-comprising cartridge may be efficiently stackable with other such cartridges, for example in a carton. In particular, by the cartridge having parallel side wall portions, the cartridge can, for example, be sandwiched between two neighboring cartridges, with the first side wall portion being able to closely approach a side wall portion of one of the neighboring cartridges, whilst the parallel second side wall portion is also able to closely approach a side wall portion of the other of the neighboring cartridges.

In some embodiments, the cartridge comprises a first thermoplastic component that includes the cover portion, and a second thermoplastic component that includes the base portion, with the first and second thermoplastic components being welded to each other.

Welding the first and second thermoplastic components may provide a robust and straightforwardly implementable way of manufacturing the cartridge. The welding may be effected in any suitable manner. Particular mention is made of mirror welding or laser welding being used to weld the first and second thermoplastic components to each other.

The thermoplastic included in the first and second thermoplastic components can be of any suitable type. In some embodiments, each of the first and second thermoplastic components comprise a polyolefin, such as polypropylene.

Polypropylene may assist to provide rigidity to the cartridge, capable of withstanding the vapor pressure of the cleaning liquid contained in the cartridge's interior space, for example during storage and transportation of the cartridge. Moreover, a relatively robust polypropylene weld seam may be provided via crystallization of molten polypropylene during the welding process.

In some embodiments, the second thermoplastic component comprises a welding rib for welding to a further welding rib included in the first thermoplastic component to form an internal rib extending within the hollow section when the first and second thermoplastic components are welded to each other.

The internal rib can assist to ensure that the first and second thermoplastic components are securely welded to each other, as well as guiding flow of the cleaning liquid in the internal space.

In some embodiments, the internal rib extends between the second end wall portion and the first end wall portion, so as to separate the interior space into a pair of chambers. An opening may nonetheless be provided for allowing the cleaning liquid to flow from the chamber in which the cleaning liquid is initially received from the shaver cleaning station to the chamber from which the cleaning liquid is subsequently transported back to the shaver cleaning station.

In some embodiments, the second thermoplastic component further comprises a mirror rib that mirrors shape and extension of the welding rib without being welded when the first and second thermoplastic components are welded to each other.

Whilst there is no weld to the mirror rib when the first and second thermoplastic components are welded to each other, by the mirror rib mirroring shape and extension of the welding rib, the risk of warping of the base portion during manufacture may be minimized.

In some embodiments, the cartridge comprises an external surface facing away from the interior space, with the external surface being included in each of the first side wall portion, the second side wall portion, the first end wall portion and the second end wall portion.

In such embodiments, the external surface may comprise a first surface portion of the first thermoplastic component, and a second surface portion of the second thermoplastic component.

The first and second surface portions may be separated from each other by the weld seam.

Alternatively, or additionally, the first and second surface portions of the cartridge's external surface may be aligned with each other.

It is noted that the term “aligned” in this context may mean that an offset between the first and second surface portions is limited to being 0.6 mm or less, preferably 0.4 mm or less.

The aligned, in other words flush, first and second surface portions on respective sides of the weld seam may assist to balance compactness/packability of the cartridge with the requirement for the cartridge's capacity for the cleaning liquid to be suitably large.

Put differently, the second thermoplastic component that comprises the base portion may not substantially protrude sideways beyond a virtual plane defined by an external surface, for example the first surface portion of the first thermoplastic component.

In this respect, the enhanced compactness/packability of the cartridge resulting from the first side wall portion axially extending from the first end wall portion to reach the second end wall portion may entail reduction in volume of the cartridge's interior space relative to, for example, a cartridge whose side wall portion comprises an outwardly protruding region arranged along the side wall portion between where the side wall portion meets the cartridge's end wall portions. This is because the outwardly protruding region may assist to increase the volume of the interior space.

However, by the first and second surface portions being aligned with each other, the cartridge may be designed to have a larger internal volume than, for example, a cartridge in which the second surface portion outwardly protrudes beyond the first surface portion so that the inboard first surface portion restricts the volume of the interior space and the outboard second surface portion defines the outermost profile of the cartridge.

It is noted that the cartridge according to any of the embodiments disclosed herein may include the cleaning liquid, with the cleaning liquid being contained in the cartridge's interior space.

Thus, the user can be conveniently supplied with a cartridge whose interior space is pre-filled with the cleaning liquid.

According to a second aspect of the present disclosure, there is provided a method for manufacturing a cartridge according to any of the embodiments disclosed herein, the method comprising molding the base portion from thermoplastic.

Particular mention is made of injection molding the base portion from thermoplastic.

In some embodiments, the method comprises welding the first thermoplastic component and the second thermoplastic component to each other while the first thermoplastic component and the second thermoplastic component are aligned by a tooling member so that the first surface portion and the second surface portion are aligned with each other.

Thus, the tooling member, for example work piece carrier, can assist to align the first and second thermoplastic components, for instance without such alignment having to be provided by the structure of the first and/or second thermoplastic component itself/themselves. The latter can assist to provide a more compact cartridge because alignment features can be omitted from the first and second thermoplastic components.

In some embodiments, a gap is initially defined at an interfacial region between the first thermoplastic component and the second thermoplastic component for subsequently receiving molten thermoplastic from the first and second thermoplastic components during the welding.

In such embodiments, the tooling member may be arranged to block egress of the molten thermoplastic from the gap. Thus, the risk of an undesirable bulge of the thermoplastic beyond the external surface at the weld seam may be reduced. This may assist to enhance visual appearance of the cartridge, as well as assisting to minimize the risk of the weld seam hindering insertion of the cartridge into the shaver cleaning station's slot.

Further provided is a shaver cleaning station assembly comprising the cartridge according to any of the embodiments described herein, a shaver cleaning station in which the cartridge is insertable, and optionally a shaver for docking in the shaver cleaning station.

### BRIEF DESCRIPTION OF THE DRAWINGS

FIG. 1 provides a cross-sectional view of a shaver cleaning station assembly according to an example;

FIGS. 2A to 2F provide various views of an exterior of a shaver cleaning station cartridge according to an example;

FIG. 3 provides a view of an interior of a first thermoplastic component of the cartridge shown in FIGS. 2A to 2F;

FIGS. 4A and 4B provide views of a second thermoplastic component of the cartridge shown in FIGS. 2A to 2F;

FIG. 5A provides a cross-sectional view depicting approach of the first and second thermoplastic components respectively shown in FIGS. 3 and 4A/4B towards each other during manufacture of the cartridge;

FIG. 5B provides a cross-sectional view depicting welding of the first and second thermoplastic components respectively shown in FIGS. 3 and 4A/4B to each other;

FIGS. 6A and 6B provide enlarged views depicting welding of the first and second thermoplastic components according to an example; and

FIGS. 7A and 7B provide views of a second thermoplastic component according to another example.

### DETAILED DESCRIPTION OF THE INVENTION

Provided is a shaver cleaning station cartridge for inserting into a slot defined in a shaver cleaning station. The cartridge is suitable for containing cleaning liquid for cleaning a shaver docked in the shaver cleaning station. Further provided is a method for manufacturing such a cartridge.

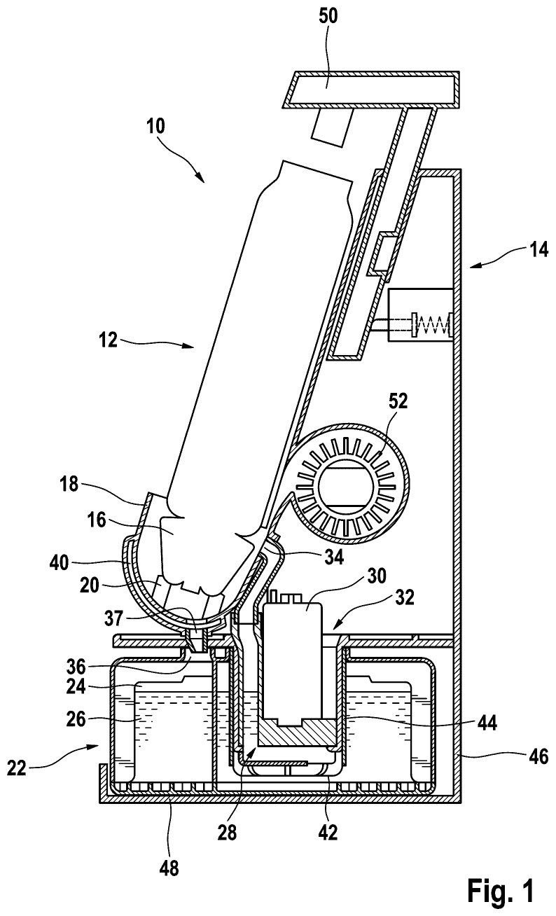

FIG. 1 shows a shaver cleaning station assembly 10 according to an example. A shaver 12 is shown docked in a shaver cleaning station 14 of the shaver cleaning station assembly 10.

A shaving head 16 of the shaver 12 may be the part of the shaver 12 that comes into contact with a body part, for example the face, of a user and shaves hair therefrom during use of the shaver 12.

The shaving head 16 can be designed in any suitable manner in order to shave hairs from the user's body part. For example, the shaving head 16 can include guard blade(s), and cutting blade(s) whose reciprocating movement, driven by a motor included in the shaver 12, relative to the guard blade(s) cuts hair between the cutting blade(s) and the guard blade(s).

The shaving head 16 may become contaminated with debris, for example hair/bristles, during use of the shaver 12, and/or moving parts, such as the cutting blade(s) and guard blade(s), of the shaving head 16 may require lubrication in order for reliable operation of the shaver 12 to be maintained.

The shaver cleaning station 14 can be used for cleaning the shaver 12, for example for cleaning the shaving head 16, when the shaver 12 is docked in the shaver cleaning station 14. The shaver cleaning station 14 may also, for example, be used to lubricate moving parts of the shaving head 16.

To this end, the shaver cleaning station 14 may include a cleaning cradle 18 for receiving at least part of the shaver 12, for example at least a portion of the shaving head 16.

In some embodiments, such as shown in FIG. 1, the shaver cleaning station 14 comprises support elements 20 for supporting the shaving head 16 when the shaving head 16 is at least partially received in the cleaning cradle 18.

The support elements 20 may comprise resilient, for example elastomeric, support elements 20. Such resilient support elements 20 may assist to protect the shaving head 16 from damage when the shaving head 16 is received in the cleaning cradle 18.

A shaver cleaning station cartridge 22 comprises an interior space 24 for containing cleaning liquid 26 that can be used to clean the shaver 12 docked in the shaver cleaning station 14. The cleaning liquid 26 may, for example, also be used to lubricate moving parts of the shaving head 16.

The cleaning liquid 26 may be formulated in any suitable manner provided that the cleaning liquid 26 is capable of cleaning, and lubricating the moving parts of, the shaver 12. In at least some embodiments, the cleaning liquid 26 comprises a cleaning agent, such as a surfactant composition, and a solvent.

The solvent may comprise ethanol and/or propanol, such as propan-2-ol.

In some embodiments, the solvent consists of ethanol and/or propanol, such as propan-2-ol.

Such an alcohol-based cleaning liquid 26 may assist with sanitizing the shaver 12 when supplied to the shaver 12 during cleaning using the shaver cleaning station 14. Moreover, drying of the shaver 12 after cleaning using such an alcohol-based cleaning liquid 26 may be relatively efficient owing to the volatility of the alcohol-based solvent.

A conveying device 28 included in the shaver cleaning station 14 may convey the cleaning liquid 26 from the cartridge's 22 interior space 24 towards the shaver 12 docked in the shaver cleaning station 14. In some embodiments, such as shown in FIG. 1, the conveying device 28 comprises a motor 30 and an impeller which, when rotated by the motor 30, causes the cleaning liquid 26 to be drawn from the cartridge's 22 interior space 24 and transported towards the shaver 12.

This type of conveying device 28 may benefit from having a relatively simple and low-cost design. Alternative conveying device 28, e.g. pump, designs can also be contemplated.

The conveying device 28 may convey the cleaning liquid 26 through an outlet 32 of the cartridge 22 and towards the shaver 12 via a supply tube 34.

In some embodiments, such as shown in FIG. 1, the supply tube 34 is arranged to carry the cleaning liquid 26 to the cleaning cradle 18, where the cleaning liquid 26 may contact, and thereby clean and optionally lubricate, the shaver's 12 shaving head 16.

Following contact with the shaver 12, the cleaning liquid 26 may return to an inlet 36 of the cartridge 22 via a liquid discharge conduit 37 included in the shaver cleaning station 14.

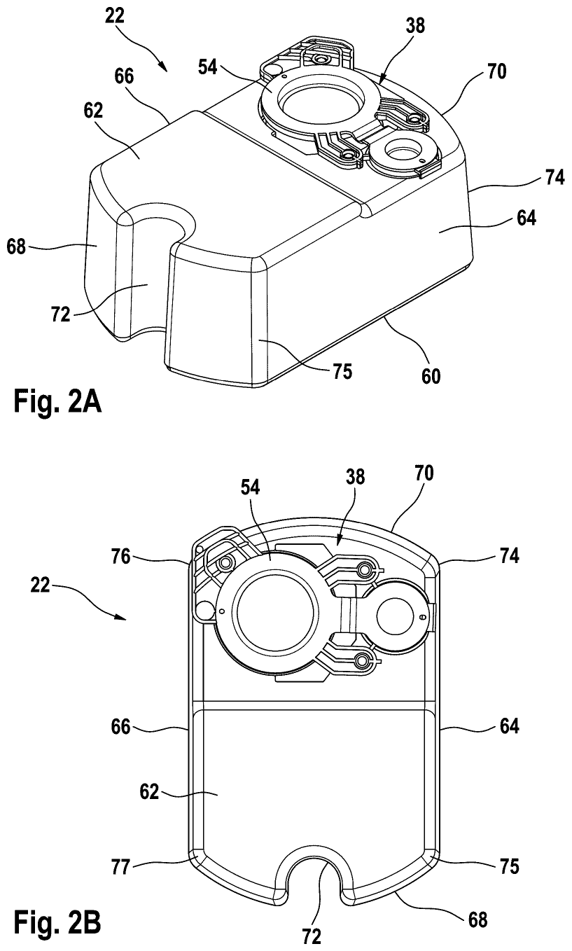

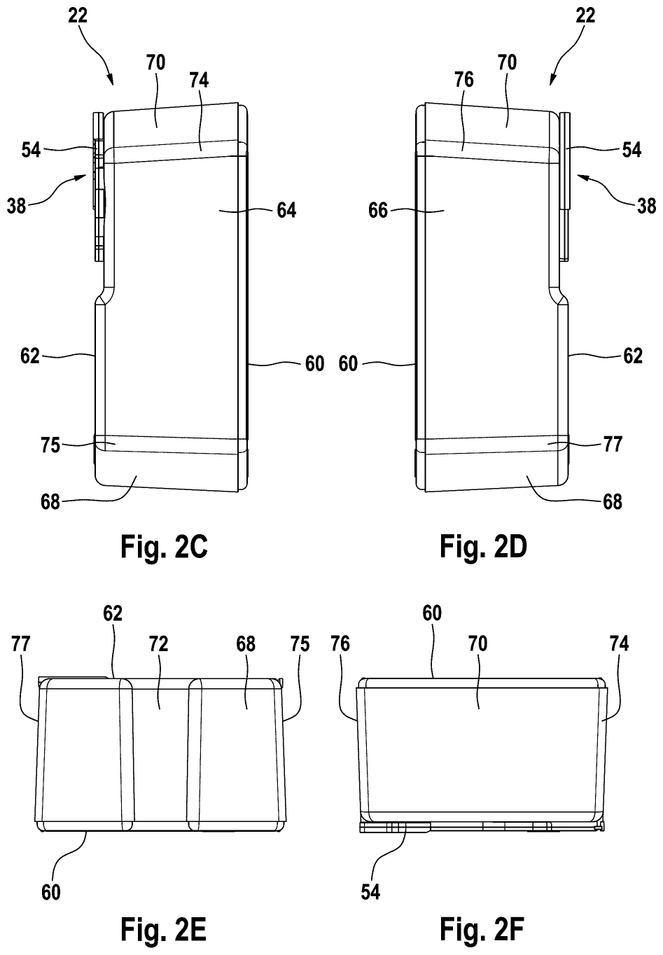

In more general terms, and referring to FIGS. 1 and 2A to 2F, the cartridge 22 includes an interface 38 for establishing a fluid route for the cleaning liquid 26 between the interior space 24 and the shaver cleaning station 14.

In embodiments, such as shown in FIG. 1, in which the cartridge 22 comprises the outlet 32 and the inlet 36, the interface 38 may include the outlet 32 and the inlet 36.

It is noted, still referring to FIG. 1, that the shaver cleaning station 14 may include an overflow arrangement 40 configured to define a maximum fill level of the cleaning liquid 26 in the cleaning cradle 18.

The overflow arrangement 40 may thus assist to ensure that only an intended part of the shaver 12, for example the shaving head 16 or part of the shaving head 16, is immersed in the cleaning liquid 26 during cleaning of the shaver 12 using the shaver cleaning station 14.

Debris, for example hair/bristles, may be carried back to the cartridge's 22 interior space 24 via the inlet 36. To avoid such debris being recirculated back to the shaver 12, the cartridge 22 may be configured to separate such debris from the cleaning liquid 26 prior to the cleaning liquid 26 being (re-)conveyed back to the shaver 12 via the outlet 32.

To this end, and as shown in FIG. 1, the cartridge 22 may include a filter element 42, for example a filter element 42 comprising a filter mesh, arranged to filter the cleaning liquid 26 being transported towards the shaver 12. For example, the filter element 42 may be arranged to filter the cleaning liquid 26 being drawn into the impeller.

In some embodiments, such as shown in FIG. 1, the cartridge 22 comprises a filter housing 44 for mounting the filter element 42.

More generally, the cartridge 22 may be removably insertable into a slot defined in the shaver cleaning station 14. In particular, the slot may be covered or coverable by a housing 46 of the shaver cleaning station 14. Alternatively or additionally, the slot may be arranged at or proximal to a base 48 of the housing 46.

The slot may be defined in any suitable manner. In some embodiments, the slot is defined between support members of the shaver cleaning station 14, for example with at least part of the housing 46 being upwardly moveable while being supported by the support members to allow the user to access the slot between the support members.

In some embodiments, such as shown in FIG. 1, the shaver cleaning station 14 comprises a holding device 50 for supporting the shaver 12 when the shaver 12 is docked in the shaver cleaning station 14. The holding device 50 may, for example, also electrically connect to the shaver 12 to enable charging of the shaver's 12 battery.

In other embodiments, the shaver cleaning station 14 does not include such a holding device 50. In such embodiments, the shaver 12 may nonetheless be electrically connected to the shaver cleaning station 14, to enable charging of the shaver's 12 battery, via sidewall electrical contacts of the shaver 12 contacting electrically conductive side portions of the shaver cleaning station 14 when the shaver 12 is docked in the shaver cleaning station 14.

In some embodiments, such as shown in FIG. 1, the shaver cleaning station 14 comprises a fan assembly 52 for delivering an airflow to the part(s) of the shaver 12, such as the shaving head 16, contacted by the cleaning liquid 26.

Such an airflow may assist to dry such part(s) of the shaver 12 following cleaning of the shaver 12 using the cleaning liquid 26.

It is noted at this point that the shaver cleaning station assembly 10 may include the shaver cleaning station 14 and one or both of the shaver 12 and the cartridge 22. The present disclosure also relates to the cartridge 22 by itself, as will now be explained with reference to FIGS. 2A to 7B.

FIGS. 2A to 2F provide various views of a cartridge 22 according to a non-limiting example. The depicted cartridge 22 comprises the interface 38 for establishing the fluid route for the cleaning liquid 26 between the interior space 24 and the shaver cleaning station 14 when the cartridge 22 is secured in the shaver cleaning station's 14 slot.

In some embodiments, the interface 38 comprises a first opening providing the outlet 32 and a second opening providing the inlet 36. The first opening may be larger than the second opening, for example so that at least part of the conveying device 28, for example at least part of the motor 30 included in the conveying device 28, can be received in the first opening.

The interface 38, for instance the first and second openings thereof, can be covered by a cover member 54, for example a lid, prior to use, with the cover member 54 being configured to enable the interface 38 to be accessed, for example by removing the cover member 54, when the cartridge 22 is to be received in the shaver cleaning station's 14 slot.

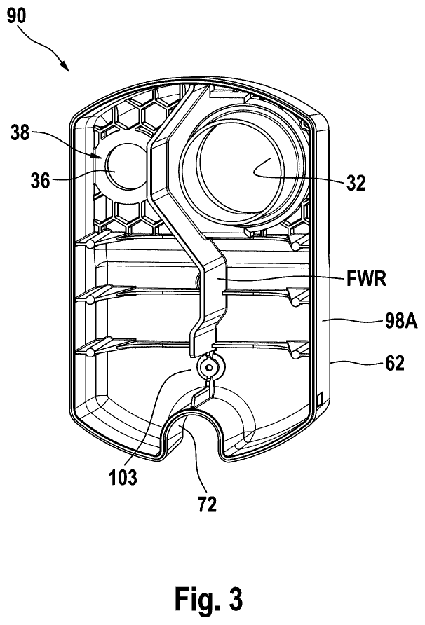

It is noted that FIGS. 2A to 2F show the cartridge 22 in a closed state with the cover member 54 attached and covering the first and second openings of the interface 38. FIG. 3 shows an upper portion of the cartridge 22 in an open state with the cover member 54 having been removed.

More generally, the cartridge 22 comprises a base portion 60 and a cover portion 62, together with a first side wall portion 64 and a second side wall portion 66 that each upstand between the base portion 60 and the cover portion 62 to define, together with the base portion 60 and the cover portion 62, a hollow section. A first end wall portion 68 closes a first end of the hollow section, and a second end wall portion 70 closes a second end of the hollow section, with the second end being opposite the first end.

The interior space 24 for receiving the cleaning liquid 26 is accordingly defined within the hollow section between the first end wall portion 68 and the second end wall portion 70.

In some embodiments, and referring to FIG. 2B, the first end wall portion 68 comprises an arcuate shape (in plan) that curves between the first side wall portion 64 and the second side wall portion 66. In particular, the first end wall portion 68 may have a convex shape that causes the first end wall portion 68 to curve outwardly in a direction away from the second end wall portion 70.

Such a convex shape for the first end wall portion 68 may assist to increase the interior space's 24 volume, for example relative to a planar or concave first end wall portion 68.

As an alternative or in addition to the first end wall portion 68 comprising the arcuate, for example convex, shape, the second end wall portion 70 may comprise an arcuate shape that curves between the first side wall portion 64 and the second side wall portion 66.

The second end wall portion 70 may, for instance, have a convex shape, for example in common with the convex shape of the first end wall portion 68, that causes the second end wall portion 70 to curve outwardly in a direction away from the first end wall portion 68. Such a convex shape for the second end wall portion 70 may assist to increase the interior space's 24 volume, for instance relative to a planar or concave second end wall portion 70.

At least part of the interface 38, for example the first opening and/or second opening thereof, may be defined in the cover portion 62.

Alternatively, or additionally, and referring to FIGS. 2A and 2B, at least part of the interface 38 may be arranged at or proximal to the second end wall portion 70, and correspondingly distal with respect to the first end wall portion 68.

For example, both the outlet 32 and the inlet 36 may be arranged at or proximal to the second end wall portion 70, and correspondingly distal with respect to the first end wall portion 68.

As best shown in FIG. 2B, the first side wall portion 64 axially extends from the first end wall portion 68, with the axial extension of the first side wall portion 64 reaching a juncture 74 at which the first side wall portion 64 meets the second end wall portion 70, at which juncture 74 the second end wall portion 70 extends, for instance arcuately extends, towards the second side wall portion 66. By the first side wall portion 64 axially extending from the first end wall portion 68 to the juncture 74 with the second end wall portion 70, a relatively compact cartridge 22 may be provided, which is more efficient to pack, store and ship.

The axial extension of the first side wall portion 64 may refer to a first side wall portion 64 whose linearity allows the first side wall portion 64 to contact a planar surface over a length of the first side wall portion 64 between a position 75 at which the first side wall portion 64 meets the first end wall portion 68 and the juncture 74 at which the first side wall portion 64 meets the second end wall portion 70.

It is noted that the planar surface may, for example, be a side wall portion 64, 66 of another cartridge 22 or a side wall of a carton for containing the cartridge 22 or cartridges 22.

The packability of the cartridge 22 may be enhanced relative to, for example, a cartridge 22 whose side wall portion 64, 66 comprises an outwardly protruding region arranged along the side wall portion 64, 66 between where the side wall portion 64, 66 meets the cartridge's 22 end wall portions 68, 70. Such an outwardly protruding region means that the side wall portion 64, 66 of such a cartridge 22 is unable to contact a planar surface over its length.

In some embodiments, and still referring to FIG. 2B, the second side wall portion 66 axially extends from the first end wall portion 68, with the axial extension of the second side wall portion 66 reaching a further juncture 76 at which the second side wall portion 66 meets the second end wall portion 70, at which further juncture 76 the second end wall portion 70 extends, for instance arcuately extends, towards the first side wall portion 64. This may enhance the compactness and packability of the cartridge 22, for reasons analogous to those provided above in respect of the axially extending first side wall portion 64 evident in, for example, FIG. 2B.

It is noted that the axial extension of the second side wall portion 66 may refer to a second side wall portion 66 whose linearity allows the second side wall portion 66 to contact a planar surface over a length of the second side wall portion 66 between a point 77 at which the second side wall portion 66 meets the first end wall portion 68 and the further juncture 76 at which the second side wall portion 66 meets the second end wall portion 70.

In some embodiments, such as shown in FIGS. 2A to 2F, the first and second side wall portions 64, 66 axially extend parallel to each other. Such parallel first and second side wall portions 64, 66 may additionally enhance the compactness and packability of the cartridge 22. In such embodiments, the hollow section of the cartridge 22, defined by the first and second side wall portions 64, 66 upstanding between the base portion 60 and the cover portion 62, may comprise a box section. Such a box section-comprising cartridge 22 may be efficiently stackable with other such cartridges 22, for example in a carton.

As best shown in FIG. 2B, the first end wall portion 68 is distinguished from the second end wall portion 70 at least in that the first end wall portion 68 comprises a mounting feature 72 for engaging with a locating part, such as a post or support member, of the shaver cleaning station 14 during securing of the cartridge 22 in the slot.

Evident in FIGS. 2A, 2B and 2E is that the mounting feature 72 comprises, for example is in the form of, an indentation defined in the first end wall portion 68, in which indentation at least a portion of the locating part is receivable.

It is noted that the interior space 24 wrapping partially around the indentation can assist to maximize the interior space's 24 volume in spite of inclusion of the indentation in the mounting feature 72.

In embodiments, such as that shown in FIGS. 2A to 2F, in which the convex first end wall portion 68 is combined with the indentation-comprising mounting feature 72, the increase in the interior space's 24 volume provided by the convex first end wall portion 68 may assist to counteract loss of volume caused by inclusion of the indentation.

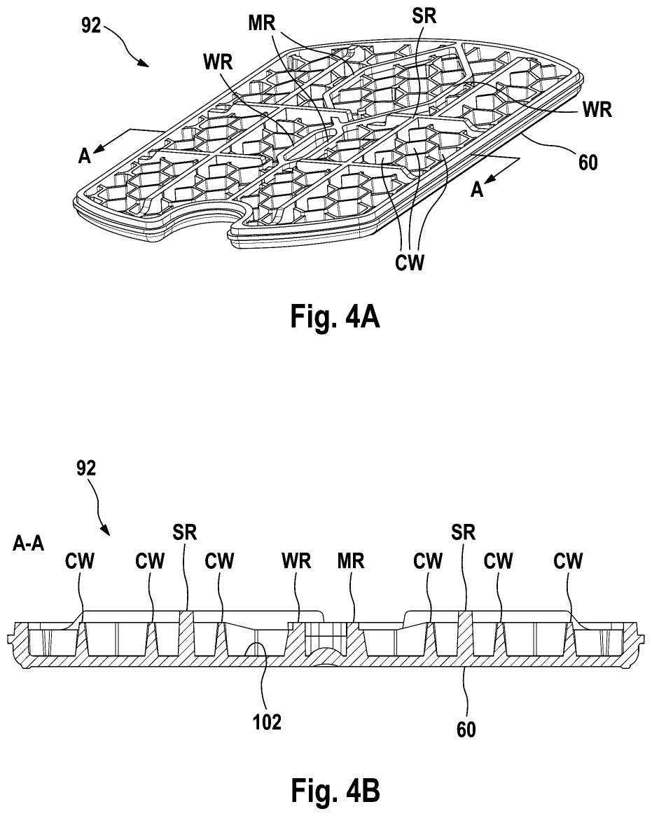

Referring now to FIGS. 3, 4A and 4B, a first thermoplastic component 90 (shown in FIG. 3) includes the cover portion 62, and a second thermoplastic component 92 (shown in FIGS. 4A and 4B) includes the base portion 60.

The first thermoplastic component 90 can be formed by molding, with particular mention being made of injection molding. The second thermoplastic component 90 can also be formed by molding, particularly injection molding.

In some embodiments, the first thermoplastic component 90 is an injection molded first thermoplastic component 90, and the second thermoplastic component 92 is an injection molded second thermoplastic component 92.

The first and second thermoplastic components 90, 92, for instance the first and second injection molded thermoplastic components 90, 92, can be joined, for example welded, to each other.

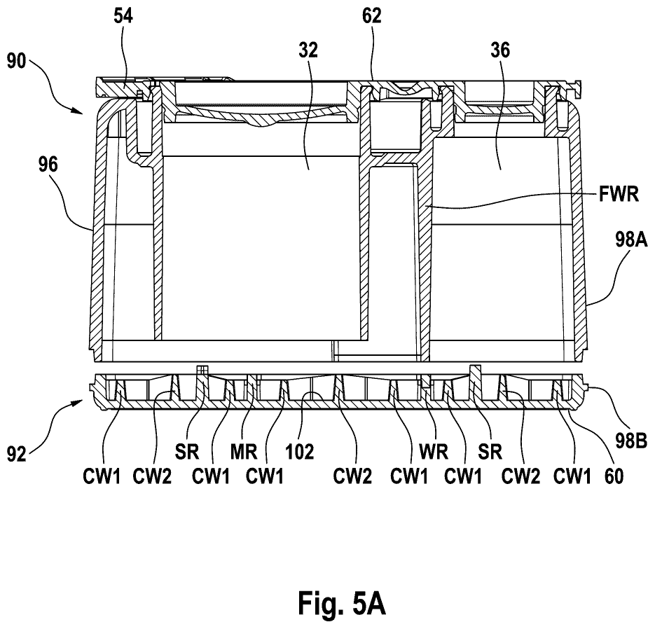

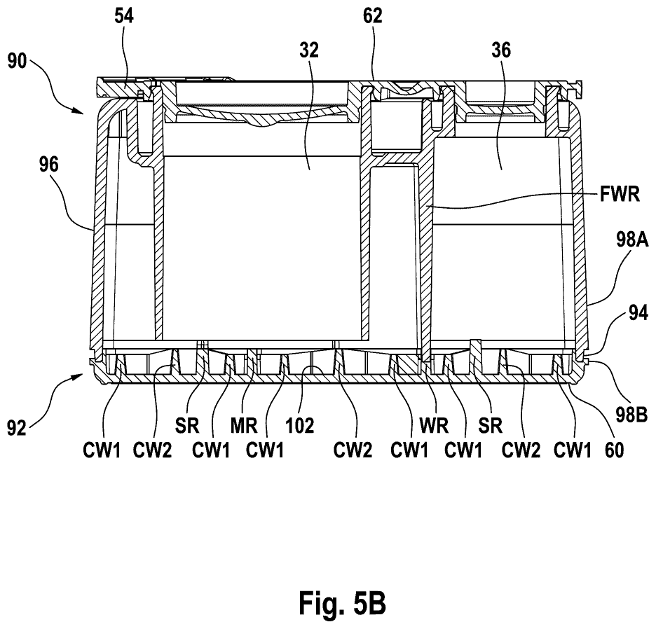

Referring to FIG. 5B, a weld seam 94 may be provided between the first and second thermoplastic components 90, 92 when the first and second components 90, 92 are welded to each other.

Welding the first and second thermoplastic components 90, 92 may provide a robust and straightforwardly implementable way of manufacturing the cartridge 22. The welding may be effected in any suitable manner. Particular mention is made of mirror welding or laser welding being used to weld the first and second thermoplastic components 90, 92 to each other.

The thermoplastic included in the first and second thermoplastic components 90, 92 can be of any suitable type. In some embodiments, each of the first and second thermoplastic components 90, 92 comprise a polyolefin, such as polypropylene.

Polypropylene may assist to provide rigidity to the cartridge 22, capable of withstanding the vapor pressure of the cleaning liquid 26 contained in the cartridge's 22 interior space 24, for example during storage and transportation of the cartridge 22. Moreover, a relatively robust polypropylene weld seam may be provided via crystallization of molten polypropylene during the welding process.

In some embodiments, and still referring to FIG. 5B, the cartridge 22 comprises an external surface 96 facing away from the interior space 24, with the external surface 96 being included in each of the first side wall portion 64, the second side wall portion 66, the first end wall portion 68 and the second end wall portion 70.

In such embodiments, the external surface 96 may comprise a first surface portion 98A of the first thermoplastic component 90, and a second surface portion 98B of the second thermoplastic component 92. The first and second surface portions 98A, 98B may be separated from each other by the weld seam 94.

FIG. 5B shows the first and second surface portions 98A, 98B of the cartridge's 22 external surface 96 being aligned with each other. It is noted that the term “aligned” in this context may mean that an offset between the first and second surface portions 98A, 98B is limited to being 0.6 mm or less, preferably 0.4 mm or less.

The aligned, in other words flush, first and second surface portions 98A, 98B on respective sides of the weld seam 94 may assist to balance compactness/packability of the cartridge 22 with the requirement for the cartridge's 22 capacity for the cleaning liquid 26 to be suitably large. In this respect, the enhanced compactness/packability of the cartridge 22 resulting, for example, from the first side wall portion 64 axially extending from the first end wall portion 68 to reach the second end wall portion 70 may entail reduction in volume of the cartridge's 22 interior space 24 relative to, for example, a cartridge 22 whose side wall portion 64, 66 comprises an outwardly protruding region arranged along the side wall portion 64, 66 between where the side wall portion 64, 66 meets the cartridge's 22 end wall portions 68, 70. This is because the outwardly protruding region may assist to increase the volume of the interior space 24.

However, by the first and second surface portions 98A, 98B being aligned with each other, the cartridge 22 may be designed to have a larger internal volume than, for example, a cartridge 22 in which the second surface portion 98B outwardly protrudes beyond the first surface portion 98A so that the inboard first surface portion 98A restricts the volume of the interior space 24 and the outboard second surface portion 98B defines the outermost profile of the cartridge 22.

It is noted that the aligned first and second surface portions 98A, 98B may be present at the indentation, for example notch, included in the mounting feature 72.

Whilst the profile of the indentation that engages with the locating part of the shaver cleaning station 14 can be provided by only one of the first and second thermoplastic components 90, 92, the aligned first and second surface portions 98A, 98B at the indentation may mean that both of the first and second thermoplastic components 90, 92 contribute to the profile of the indentation.

This may assist to maximize the volume of the cartridge's 22 interior space 24, for example relative to the scenario in which the outer profile of the indentation that engages with the locating part is provided by only one of the first and second thermoplastic components 90, 92, with the other of the first and second thermoplastic components 92, 90 having an inner profile that is recessed relative to the outer profile.

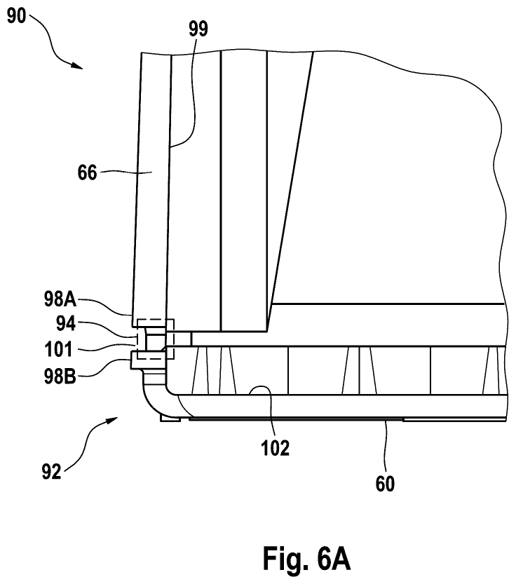

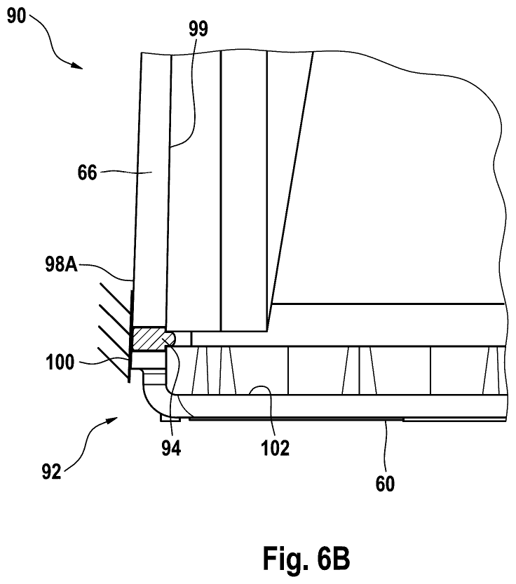

Referring now to FIGS. 6A and 6B, a method for manufacturing such a cartridge 22 comprises welding the first thermoplastic component 90 and the second thermoplastic component 92 to each other, for example via laser welding or mirror welding.

It is noted that FIGS. 6A and 6B show the first and second surface portions 98A, 98B of the cartridge's 22 external surface 96, as well as an internal surface 99 included in each of the first side wall portion 64, the second side wall portion 66, the first end wall portion 68 and the second end wall portion 70.

The first side wall portion 64, the second side wall portion 66, the first end wall portion 68 and the second end wall portion 70 may be shaped such that the external surface 96 and the internal surface 99 each follow extension of the respective wall portion 64, 66, 68, 70 to which they belong.

In some embodiments, and referring to FIG. 6B, the first thermoplastic component 90 and the second thermoplastic component 92 are aligned by a tooling member 100 so that the first surface portion 98A and the second surface portion 98B are aligned with each other.

Thus, the tooling member 100, for example work piece carrier, can assist to align the first and second thermoplastic components 90, 92, for instance without such alignment having to be provided by the structure of the first and/or second thermoplastic component 90, 92 itself/themselves. The latter can assist to provide a more compact cartridge 22 because alignment features can be omitted from the first and second thermoplastic components 90, 92.

It is noted that the limited offset (less than 0.6 mm, preferably less than 0.4 mm) between the first and second surface portions 98A, 98B may reflect the size and tolerance of the tooling member 100, for example the size and tolerance of the work piece carrier, which may additionally serve as a welding shield, as explained in more detail herein below.

In some embodiments, and referring to FIG. 6A, a gap 101 is initially defined at an interfacial region between the first thermoplastic component 90 and the second thermoplastic component 92. The gap 101 is for subsequently receiving molten thermoplastic from the first and second thermoplastic components 90, 92 during the welding, as shown in FIG. 6B.

In such embodiments, the tooling member 100, for example work piece carrier, may be arranged to block egress of the molten thermoplastic from the gap 101. By the tooling member 100 being arranged to block egress of the molten thermoplastic from the gap 101, the risk of an undesirable bulge, in other words a burr or protrusion, of excess thermoplastic material beyond the external surface 96 at the weld seam 94 may be reduced. This may assist to enhance visual appearance of the cartridge 22, as well as helping to minimize the risk of the weld seam 94 hindering insertion of the cartridge 22 into the shaver cleaning station's 14 slot.

It is noted that appropriate control can be exerted over the combination of dimensions and tolerances of the cartridge 22 and the tooling member 100, for example work piece carrier, in order to realize the aligned first and second surface portions 98A, 98B and the weld seam 94 that does not protrude beyond the first and second surface portions 98A, 98B.

The weldable portions of the first and second thermoplastic components 90, 92 and the gap 101 may be designed so that there is about 50% thermoplastic material flow to the gap 101. This may assist to avoid protrusion of the thermoplastic material.

In some embodiments, such as shown in FIGS. 3 to 5B, the second thermoplastic component 92 comprises a welding rib WR for welding to a further welding rib FWR included in the first thermoplastic component 90 to form an internal rib extending within the hollow section when the first and second thermoplastic components 90, 92 are welded to each other.

The internal rib can assist to ensure that the first and second thermoplastic components 90, 92 are securely welded to each other, as well as guiding flow of the cleaning liquid 26 in the internal space 24.

It is noted that the above-described maximum tolerance of 0.6 mm, preferably 0.4 mm, may refer to a sidewise misalignment of the first and second surface portions 98A, 98B respectively from the top, first thermoplastic component 90 and from the bottom, second thermoplastic component 92. In order to satisfy this tolerance, it is noted that the welding walls WR, FWR/projections to be melted and connected may be intentionally slightly non-aligned.

In some embodiments, the internal rib extends between the second end wall portion 70 and the first end wall portion 68, so as to separate the interior space 24 into a pair of chambers. An opening 103 (see FIG. 3) may nonetheless be provided for allowing the cleaning liquid 26 to flow from the chamber in which the cleaning liquid 26 is initially received via the inlet 36, to the chamber from which the cleaning liquid 26 is subsequently transported to the shaver cleaning station 14 via the outlet 32.

In embodiments in which the outlet 32 and the inlet 36 are both at or proximal to the second end wall portion 70, and correspondingly distal with respect to the first end wall portion 68, the opening 103 may be arranged adjacent or proximal to the first end wall portion 68 so that the cleaning liquid 26 received in the interior space 24 via the inlet 36 is forced by the internal rib to travel first towards the first end wall portion 68 and then back towards the second end wall portion 70 (at or proximal to which the outlet 32 is arranged).

This flow path may assist with separation of debris from the cleaning liquid 26, for example since the flow path may provide more opportunity for sedimentation of such debris.

In some embodiments, such as shown in FIGS. 4A to 5B, 7A and 7B, the second thermoplastic component 92 further comprises a mirror rib MR that mirrors shape and extension of the welding rib WR without being welded when the first and second thermoplastic components 90, 92 are welded to each other.

Whilst there is no weld to the mirror rib MR when the first and second thermoplastic components 90, 92 are welded to each other, by the mirror rib MR mirroring shape and extension of the welding rib WR, the risk of warping of the base portion 60 during manufacture may be minimized.

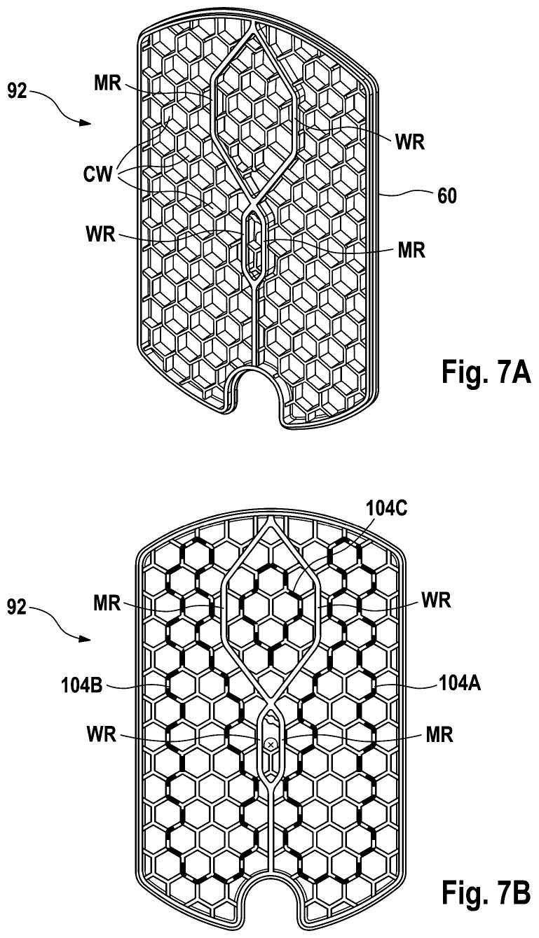

In some embodiments, and as best shown in FIGS. 4A, 7A and 7B, one or more intersections at which the welding rib WR crosses the mirror rib MR is or are provided. For example, an arrangement of the welding rib WR and the mirror rib MR may approximate a figure of eight when the base portion's 60 internal surface 102 is viewed in plan.

In some embodiments, and as best shown in FIGS. 4A, 4B, 7A and 7B, a plurality of compartment walls CW protrude from the internal surface 102 of the base portion 60 into the interior space 24, with the compartment walls CW defining compartments in which debris is collectable from the cleaning liquid 26 received in the interior space 24 from the shaver cleaning station 14.

The compartments may provide receptacles in which sedimentation of the debris, for example bristles etc., contaminating the cleaning liquid 26 can take place.

The cartridge 22 may include the filter element 42, for example a filter mesh, as well as the compartments defined by the compartment walls CW.

In such embodiments, the sedimentation of the debris in the compartments can assist to alleviate clogging of the filter element 42.

In some embodiments, such as shown in FIGS. 5A, 5B, 7A and 7B, the compartment walls CW comprise first compartment walls CW1 and second compartment walls CW2, with the second compartment walls CW2 protruding further into the interior space 24 from the internal surface 102 than the first compartment walls CW1.

The enhanced stiffness/rigidity provided by the taller second compartment walls CW2 can assist manufacturing of the base portion 60, for example as well as facilitating welding of the second thermoplastic component 92 that comprises the base portion 60 to the first thermoplastic component 90 comprising the cover portion 62. In particular, the greater stiffness/rigidity of the base portion 60 can reduce the risk of warping of the base portion 60 that can otherwise hamper welding, for example mirror welding, of the first thermoplastic component 90 to the second thermoplastic component 92. In this regard, the taller second compartment walls CW2 may reduce the risk of bulging of the base portion 60 that may otherwise occur during, for instance, a molding, for example injection molding, process used to manufacture the base portion 60.

The enhanced stiffness/rigidity of the base portion 60 can also assist to confer structural robustness to the cartridge 22, in particular in terms of assisting the base portion 60 to withstand the vapor pressure of the cleaning liquid 26 contained in the cartridge's interior space 24, for example during storage and transportation of the cartridge 22. This may be particularly advantageous in embodiments in which the solvent included in the cleaning liquid 26 comprises ethanol and/or propanol.

In this manner, the taller second compartment walls CW2 may assist to minimize bulging that may happen during shipping of the cartridge 22, for example on container ships, noting that during shipping the cartridges 22 containing the cleaning liquid 26 may be heated up to 80° C., thereby increasing pressure inside the cartridge 22 by about 1 bar. The taller second compartment walls CW2 may therefore assist to reduce the risk of deformation of the cartridge's 22 wall portions 64, 66, 68, 70 caused by the increased pressure, particularly in the case of polypropylene wall portions 64, 66, 68, 70.

It is noted that the shorter first compartment walls CW1 may assist to minimize fluid flow inefficiency, whilst also assisting to reduce the amount of material, for example thermoplastic, included in the base portion 60.

In some embodiments, the second compartment walls CW2 protrude into the interior space 24 from the internal surface 102 by at least 10%, preferably by at least 20%, more than the first compartment walls' CW1 protrusion into the interior space 24 from the internal surface 102.

Alternatively, or additionally, the second compartment walls CW2 may protrude from the internal surface 102 to a height of 3.5 mm to 4 mm, for example about 3.7 mm, with the first compartment walls CW1 protruding from the internal surface 102 to a height of 2.7 mm to 3.2 mm, for example about 2.9 mm.

Alternatively, or additionally, the base portion 60 may have a thickness, as defined between the base portion's 60 external surface 96 and the base portion's internal surface 102, of 0.8 mm to 1.5 mm, for example about 1.2 mm.

Alternatively, or additionally, the cover portion 62 may have a thickness, as defined between the cover portion's 62 external surface 96 and the cover portion's internal surface of at least 0.65 mm.

More generally, it is noted that owing to the second compartment walls CW2 defining at least opposite portions of a regular polygonal or circular shape of one or more of the compartments, when the internal surface 102 is viewed in plan, the second compartment walls CW2 may add stiffness/rigidity to the base portion 60 further to that intrinsically provided by the regular polygonal or circular shape of the compartment(s).

In some embodiments, the second compartment walls CW2 define the entirety of the regular polygonal or circular shape of the compartment(s).

Alternatively, the second compartment walls CW2 may define the opposite portions of the regular polygonal or circular shape of each of one or more of the compartments, but with the remainder of the regular polygonal or circular shape being defined by the first compartment walls CW1.

Examples of regular polygonal shapes for the compartments whose opposite portions are defined by the taller second compartment walls CW2 include square, hexagonal and octagonal. Particular mention is made of hexagonal compartments, in other words compartments that are each delimited by six hexagonally arranged compartment walls CW. In such an example, the taller second compartment walls CW2 may define one, two or all three opposite pairs of the hexagonally arranged compartment walls CW.

In some embodiments, and referring to FIG. 7B, the second compartment walls CW2 comprise a first interconnected arrangement 104A of second compartment walls CW2, with the first interconnected arrangement 104A being elongate and longitudinally extending between the first end wall portion 68 and the second end wall portion 70, adjacent to the first side wall portion 64.

By increasing the height of the compartment walls CW in this way, adjacent to the first side wall portion 64, the enhanced stiffness provided by the second compartment walls CW2 may be provided in a region where there is more risk of bulging due to expansion of vapor from the cleaning liquid 26 in the interior space 24.

In some embodiments, and still referring to FIG. 7B, the second compartment walls CW2 comprise a second interconnected arrangement 104B of second compartment walls CW2, with the second interconnected arrangement 104B being elongate and longitudinally extending between the first end wall portion 68 and the second end wall portion 70, adjacent to the second side wall portion 66.

This may also assist to enhance stiffness provided by the second compartment walls CW2 in a (further) region where there is more risk of bulging of the base portion 60 due to expansion of vapor from the cleaning liquid 26 in the interior space 24.

In some embodiments, the second compartment walls CW2 include the first interconnected arrangement 104A and the second interconnected arrangement 104B, for example with the first and second interconnected arrangements 104A, 104B being distinct from each other, in other words without sharing second compartment wall(s) CW2 common to both of the first and second interconnected arrangements 104A, 104B.

In such embodiments, the symmetry provided by inclusion of both of the first and second interconnected arrangements 104A, 104B may assist manufacture of the base portion 60, for example by minimizing the risk of warping during molding of the base portion 60.

In some embodiments, the second compartment walls CW2 comprise a third interconnected arrangement 104C of second compartment walls CW2, with the third interconnected arrangement 104C being arranged in a central region between the first side wall portion 64 and the second side wall portion 66.

In such embodiments, the central region may, for example, be closer to the second end wall portion 70 than the first end wall portion 68.

Such a third interconnected arrangement 104C of second compartment walls CW2 can further assist to reduce the risk of bulging due to containment of the cleaning liquid 26 in the interior space 24.

In some embodiments, and referring again to 4A and 4B, a plurality of elongate support ribs SR protrude from the internal surface 102 of the base portion 60 into the interior space 24, with the plurality of elongate support ribs SR comprising at least one longitudinal support rib extending between the first end wall portion 68 and the second end wall portion 70 and/or at least one lateral support rib extending between the first side wall portion 64 and the second side wall portion 66.

The elongate support ribs SR may provide enhanced stiffness/rigidity of the base portion 60. In particular, the combination of the second compartment walls CW2 and the elongate support rib(s) SR may provide particularly enhanced structural robustness to the base portion 60.

In some embodiments, the at least one longitudinal support rib comprises a first longitudinal support rib extending adjacent to the first side wall portion 64, and a second longitudinal support rib extending adjacent to the second side wall portion 66, with the first longitudinal support rib being spaced apart from the second longitudinal support rib.

Alternatively, or additionally, the at least one lateral support rib SR may comprise a first lateral support rib, and a second lateral support rib spaced apart from the first lateral support rib.

In some embodiments, such as shown in FIGS. 4A and 4B, both the longitudinal support rib(s) and the lateral support rib(s) are included in the base portion 60, for example in combination with the compartment walls CW comprising the first and second compartment walls CW1, CW2.

Such a base portion 60 may benefit from being particularly robust, thereby facilitating fabrication of the cartridge 22, as well as conferring enhanced robustness on the manufactured cartridge 22.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention. Any reference signs in the claims should not be construed as limiting the scope.

What is claimed is:

1. A shaver cleaning station cartridge for inserting into a slot defined in a shaver cleaning station and for containing cleaning liquid suitable for cleaning a shaver docked in the shaver cleaning station, the cartridge comprising:
a base portion;
a cover portion;
a first side wall portion and a second side wall portion that each upstand between the base portion and the cover portion to define, together with the base portion and the cover portion, a hollow section;
a first end wall portion closing a first end of the hollow section;
a second end wall portion closing a second end of the hollow section, the second end being opposite the first end, an interior space for receiving the cleaning liquid being defined within the hollow section between the first end wall portion and the second end wall portion; and
an interface for establishing a fluid route for the cleaning liquid between the interior space and the shaver cleaning station when the cartridge is secured in the slot,
wherein a plurality of compartment walls protrude from an internal surface of the base portion into the interior space, the compartment walls defining compartments in which debris is collectable from the cleaning liquid received in the interior space from the shaver cleaning station, wherein the compartment walls comprise first compartment walls and second compartment walls, the second compartment walls protruding further into the interior space from the internal surface than the first compartment walls, wherein the second compartment walls define at least opposite portions of a regular polygonal or circular shape of one or more of the compartments, when the internal surface is viewed in plan.

2. The cartridge of claim 1, wherein the second compartment walls comprise a first interconnected arrangement of second compartment walls, the first interconnected arrangement being elongate and longitudinally extending between the first end wall portion and the second end wall portion, adjacent to the first side wall portion.

3. The cartridge of claim 1, wherein the second compartment walls comprise a second interconnected arrangement of second compartment walls, the second interconnected arrangement being elongate and longitudinally extending between the first end wall portion and the second end wall portion, adjacent to the second side wall portion.

4. The cartridge of claim 1, wherein the second compartment walls comprise a third interconnected arrangement of second compartment walls, the third interconnected arrangement being arranged in a central region between the first side wall portion and the second side wall portion, the central region being closer to the second end wall portion than the first end wall portion.

5. The cartridge of claim 1, wherein a plurality of elongate support ribs protrude from the internal surface of the base portion into the interior space, the plurality of elongate support ribs comprising at least one longitudinal support rib extending between the first end wall portion and the second end wall portion and/or at least one lateral support rib extending between the first side wall portion and the second side wall portion.

6. The cartridge of claim 1, wherein the first end wall portion is distinguished from the second end wall portion at least in that the first end wall portion comprises a mounting feature for engaging with a locating part of the shaver cleaning station during securing of the cartridge in the slot; optionally wherein the mounting feature comprises an indentation defined in the first end wall portion, in which indentation at least a portion of the locating part is receivable.

7. The cartridge of claim 1, wherein the first side wall portion axially extends from the first end wall portion, the axial extension of the first side wall portion reaching a juncture at which the first side wall portion meets the second end wall portion, at which juncture the second end wall portion extends towards the second side wall portion.

8. The cartridge of claim 7, wherein the second side wall portion axially extends from the first end wall portion, the axial extension of the second side wall portion reaching a further juncture at which the second side wall portion meets the second end wall portion, at which further juncture the second end wall portion extends towards the first side wall portion.

9. The cartridge of claim 8, wherein the first and second side wall portions axially extend parallel to each other.

10. The cartridge of claim 9, comprising a first thermoplastic component comprising the cover portion, and a second thermoplastic component comprising the base portion, the first and second thermoplastic components being welded to each other, a weld seam being provided between the first and second thermoplastic components.

11. The cartridge of claim 10, wherein the second thermoplastic component comprises a welding rib for welding to a further welding rib included in the first thermoplastic component to form an internal rib extending within the hollow section when the first and second thermoplastic components are welded to each other, wherein the second thermoplastic component further comprises a mirror rib that mirrors shape and extension of the welding rib without being welded when the first and second thermoplastic components are welded to each other.

12. The cartridge of claim 10, comprising an external surface facing away from the interior space, the external surface being included in each of the first side wall portion, the second side wall portion, the first end wall portion and the second end wall portion, wherein the external surface comprises a first surface portion of the first thermoplastic component and a second surface portion of the second thermoplastic component, the first and second surface portions being separated from each other by the weld seam, and wherein the first and second surface portions are aligned with each other.

13. A method for manufacturing the cartridge of claim 1, the method comprising molding; optionally injection molding, the base portion from thermoplastic.

14. A method of manufacturing the cartridge of claim 12, wherein the method comprises welding the first thermoplastic component and the second thermoplastic component to each other while the first thermoplastic component and the second thermoplastic components are aligned by a tooling member so that the first surface portion and the second surface portion are aligned with each other.

15. The method of claim 14, wherein a gap is initially defined at an interfacial region between the first thermoplastic component and the second thermoplastic component for subsequently receiving molten thermoplastic from the first and second thermoplastic components during the welding, the tooling member being arranged to block egress of the molten thermoplastic from the gap.
